(19) United States
(12) Patent Application Publication
(10) Pub. No.: US 2002/0065722 A1
(43) Pub. Date: May 30, 2002

(54) System and method for presenting marketing content on a web page

(75) Inventors: Mark W. Hubbard, Maple (CA); Joseph B. Rainsberger, Toronto (CA); Ramiah Kwok-Fai Tin, Pickering (CA); Tack Tong, Scarborough (CA)

Correspondence Address: A. Bruce Clay, IBM Corporation T81/062, P.O. Box 12195, Research Triangle Park, NC, 27709, US

(73) Assignee: International Business Machines Corporation, Armonk, NY (US)

(21) Appl. No.: 09/998,111

(22) Filed: Nov. 30, 2001

(30) Foreign Application Priority Data
Nov. 30, 2000 (CA) 2327192

(51) Int. Cl. G06F 17/60

(52) U.S. Cl. 705/14

(57) ABSTRACT

The invention relates to marketing page elements (MPEs) used to achieve separation between tasks relating to the design of a web page with marketing content and the design of a means for determining what marketing content should be presented to viewers of the web page. In the preferred embodiment of the invention, a marketing page element comprises multiple marketing page element items. Data items are stored in the marketing page element, and at least one data item is associated with a marketing page element item, the data items having been selected for presentation on the web page by a marketing content selection system in accordance with a marketing strategy. Web page elements, each being connected to a marketing page element item and capable of presenting an associated data item stored in the marketing page element, can be arranged on a web page during the web page's design, without regard for the manner in which data items are to be selected by the marketing content selection system. Conversely, changes to the manner in which data items are selected by the marketing content selection system can be effected without regard for the manner in which the web page elements are to be laid out on the web page.

### FIELD OF THE INVENTION

This invention relates generally to the design of web pages. More specifically, this invention relates to a computer-based system and method for presenting marketing content to the viewer of a web page, allowing for separation between the task of web page design and the task of determining what marketing content should be presented to the viewer.

### BACKGROUND OF THE INVENTION

It is becoming increasingly common to include marketing content on web pages to be viewed by potential consumers accessing Internet web sites. Such marketing content may be presented to these viewers using a variety of marketing content elements including, for example, banner advertisements, store catalogue entries, images, text entries, and links to other web pages elsewhere on the Internet. Ideally, the marketing elements used are personalized to the individual viewer, or targeted to a specific group of potential consumers to which the individual viewer might belong.

From the perspective of the web page designer, in preparing the layout of a web page, it is typically necessary to specify the source of marketing content explicitly in the code of the web page being designed. It is also typically necessary for the web page designer to know how specific marketing-related data items will be selected for presentation on the web page at the outset, prior to the design phase, so that the code underlying the web page can be written accordingly. Thus, substantial collaboration between the web site designer and the marketing manager or marketing professional interested in delivering marketing content to potential consumers is often required.

For example, a design tool manufactured by BrightInfo.com requires the designer to correctly identify the marketing content specification (i.e., how marketing-related data items are to be selected for presentation) and to embed that specification in the web page. Unfortunately, where the design of a web page requires the marketing content specification to be embedded in the web page, it becomes increasingly difficult to separate the tasks relating to the design of the web page layout from those relating to the provision of marketing content and the application of specific marketing strategies. Hence, it is difficult for web site designers and marketing managers to perform their jobs independently of each other.

Further, some web page designers use Microsoft Corporation's proprietary Active Server Page (ASP) technology and proprietary editing tools to design their web pages, instead of other available technologies such as Java™, Java Server Pages (JSPs) and Hypertext Markup Language (HTML) which generally allow for a greater degree of code portability between different computing platforms.

U.S. Pat. No. 5,999,912 discloses a method for dynamically scheduling and displaying advertising on web pages. Ad tags placed into web pages define placeholders for advertising content on those web pages. The type of advertising content to be placed on those web pages is determined at the time the web page is designed, and the information is stored in database tables. When a user accesses the web page, an advertisement is selected using the database tables in accordance with specified parameters as defined by the HTML ad tags, and placed in the placeholders.

This method does not provide for the effective separation of tasks relating to the design of the web page and those relating to the design of a means to implement a marketing strategy for determining what marketing content should be presented on that web page to any given viewer.

U.S. Pat. No. 6,014,638 discloses a marketing and shopping system relating to the customization of advertising and marketing information based on a user's characteristics. Shoppers and merchants participate in the system by subscribing to or establishing an account with an on-line service provider.

As with U.S. Pat. No. 5,999,912, this system does not provide for the effective separation of tasks relating to the design of the web page and those relating to the design of a means to implement a marketing strategy for determining what marketing content should be presented on that web page to any given viewer.

In contrast, U.S. Pat. No. 5,907,837 discloses an information retrieval system in which information pertaining to the design of a publication and the content of the publication are separated. More specifically, the system includes a page layout for the publication of “stories” created by placing controls on a blank page. Each control delineates an area where some piece of content is to be displayed. The settings on each control specify the data source to look for the content to be displayed in that control. The content can be changed or updated by directly modifying the content stored in the data sources accessed by the system. A viewer of the publication can obtain personalized publications by using the system's searching means to obtain content that satisfies the viewer's query.

However, in the system disclosed in U.S. Pat. No. 5,907,837, while the content in a content source may be modified by a content provider, the content provider is unable to “push” specific content to an individual in accordance with a strategy or scheme determined by the content provider. Instead, in the above system, personalized information retrieved by a viewer is determined by the viewer himself from available content. The viewer will typically require special software and resources running on his machine to view this content. While separation of design information and content are achieved to a certain degree, the content provider lacks the capability of dynamically selecting personalized content to be presented to individual viewers in a manner that the content provider himself may want to specify, and for changing that specification without requiring changes to the layout or design of the publication.

Accordingly, there is a need for a system which permits for separation between the task of web page design and the task of determining what marketing content should be presented to a viewer.

### SUMMARY OF THE INVENTION

The present invention relates to a system and method for presenting marketing content on a web page, in which web page designers can add marketing content to a web page without being restricted to obtaining such content from a particular source of marketing content, and without concern for the manner in which specific marketing-related data items are selected for presentation on the web page. The invention also provides marketing managers (marketing professionals, marketing content providers) with flexibility in the design of a means for determining how data items should be selected for presentation to individual viewers of the web page without having to be concerned with the details on how the data items will be laid out on the web page.

An aspect of the present invention is a system for presenting marketing content on a web page comprising a marketing page element for storing data items, a web page where the data items stored in the marketing page element can be presented, a marketing content selection system adapted to determine what data items should be stored in the marketing page element in accordance with a marketing strategy, and a marketing content retrieval system adapted to provide those data items to the marketing page element.

An aspect of the present invention relates to a method of presenting marketing content on a web page using a marketing page element comprising the steps of selecting data items in accordance with a specified marketing strategy, retrieving those data items from a source of data items, storing those data items in the marketing page element, and presenting those data items on the web page.

It will be appreciated by those skilled in the art that the invention herein can be embodied in a computer program which can be stored in storage or transmitted as a signal, such as on a modulated carrier signal for use in a computer system, or on a network such as the Internet for use in a computer system.

### BRIEF DESCRIPTION OF THE DRAWINGS

For a better understanding of the present invention, and to show more clearly how it may be carried into effect, reference will now be made, by way of example, to the accompanying drawings which show a preferred embodiment of the present invention, and in which:

FIG. 1 is a schematic diagram illustrating the present invention;

FIG. 2 is a schematic diagram illustrating the class structure of marketing page elements; and

FIG. 3 is a flowchart illustrating the steps performed in the present invention.

### DETAILED DESCRIPTION OF THE PREFERRED EMBODIMENT

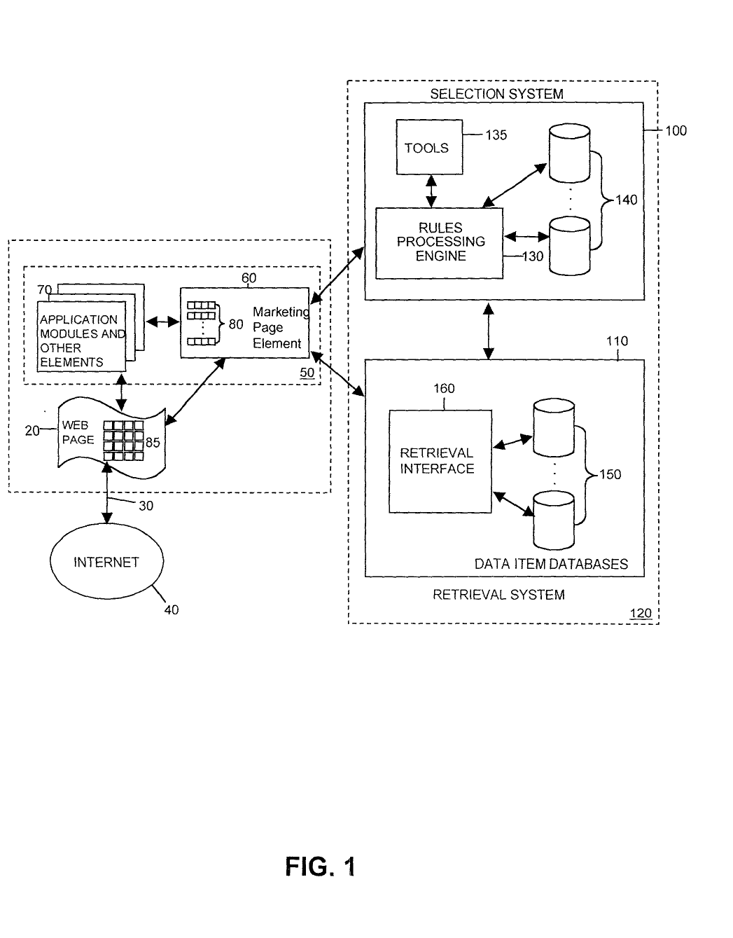

Referring to FIG. 1, a system for presenting marketing content on a web page is shown generally as 10. System 10 comprises numerous elements to facilitate the presentation of marketing-related information on a web page 20 of a web site (not shown), which can be accessed by the public through a TCP/IP connection 30 to the Internet 40. These elements of system 10 can include application components 50 for controlling the marketing content displayed on the web page 20, including a marketing page element 60 (hereinafter also referred to as an “MPE”) to be placed on the web page 20 and other application modules and elements 70. These application components 50 can reside on a web server 75.

More specifically, in accordance with the present invention, the MPE 60 comprises a collection of one or more marketing page element items 80 (hereinafter also referred to as “page element items”). A page element item 80 is an object representing a specific instance of a marketing content element (e.g. one catalog entry, one banner advertisement, etc.). A page element item 80 has numerous specific properties or specific attributes which have values associated with them. A data item, or an identifer which indicates where a data item can be retrieved, can be stored in the MPE 60 by assigning the data item or corresponding identifier to a specific attribute of a page element item 80. Thus, by requesting the value of a given specific attribute from a page element item 80, the corresponding data item can be retrieved. Where a page element item 80 comprises multiple specific attributes, multiple data items can be associated with a page element item 80. The nature of these data items will depend on the type of MPE 60 to which the particular page element item 80 belongs. For instance, if the MPE 60 is used to display catalog entry information on the web page 20, each page element item 80 may represent one product for which catalog entry information is to be displayed, and the corresponding data items might include a text description of the product, a numerical value representing the price of the product, a picture of the product, and so on.

In some instances, the code of the web page 20 on which the MPE 60 is placed will contain instructions to display or present a data item by referring directly to the specific attribute associated with the data item and retrieving its value. In other instances, object methods of the MPE 60 can be used to facilitate the retrieval of an attribute's value (i.e. a data item) for presentation on the web page 20.

During the design of the web page 20, the web page designer places an MPE 60 onto the web page 20. Subsequently, the designer writes code to perform the following tasks:

(a) upon viewing of the web page, activate the MPE 60, causing it to retrieve marketing content (i.e. one or more sets of data items);

(b) loop through the list of page element items 80, where a set of data items is associated with each page element item 80;

(c) for each page element item 80, display the associated data items in some desired layout.

To display the data items associated with a page element item 80 in a desired layout on a web page 20, multiple web page elements 85 may be defined. Each web page element 85 serves as a placeholder on the web page 20 for one data item. A web page element 85 may be a cell of a table or a space allocated for an image, for example. A set of web page elements 85 may be linked to a page element item 80, and each web page element 85 in that set can access a specific data item associated with the page element item 80 by referring to the value of the corresponding specific attribute of the page element item 80. The code which causes the data item to be displayed in the web page element 85 can then be executed. By changing the layout of the web page elements 85 on a web page 20, the appearance of data items to appear on the web page 20 can be customized and modified.

For example, the web page designer may wish to add a Catalog Entry MPE to a web page 20. This particular MPE 60 typically represents a list of products in a store's catalog, and each page element item 80 represents an individual product of that list. The web page designer is made aware of the types of data items available for display or presentation relating to any given product (i.e. the web page designer knows what specific attributes a Catalog Entry page element item has). The web page designer can access the values of these specific attributes directly, or indirectly through methods of the Catalog Entry MPE, and enable all data items associated with the Catalog Entry MPE to be displayed in, for example, a table format. The data items relating to a product may include, for example, a product identifier (e.g. an SKU), a product description, and/or an image or link to the image. The web page designer may arrange the table so that for each product in the list (i.e. for each page element item 80), the associated data items are displayed in a row of the table, allocating a specific type of data item to each column. Thus, each cell of the table is a web page element 85 used to display one data item stored in the MPE 60 relating to a specific product.

In other web page designs, the manner in which these data items are displayed, however, can be laid out in any format in which the web page designer may desire. Advantageously, the web page designer can design the web page 20 with only the knowledge of what types of data items are available for display (i.e. the available specific attributes of each page element item 80) relating to the specific MPE 60. The web page designer does not need to know where the data items to be stored in the MPE 60 will come from, or how those data items will be selected.

Each MPE 60 is connected to a marketing content selection system 100 (hereinafter also referred to as “selection system”), and a marketing content retrieval system 110 (hereinafter also referred to as “retrieval system”). Collectively, the selection system 100 and retrieval system 110 may be referred to as a marketing content server 120; however, the system need not reside physically on a common server.

The selection system 100 is designed to select data items to be stored in the MPE 60 for subsequent display on a web page 20. Importantly, the means for selecting data items is designed in accordance with a specified marketing strategy, and not, for instance, purely at random. A marketing strategy is a strategy in which a specific type of marketing content is selected for presentation or display to a specific segment of the viewer (i.e. consumer) population. For example, a marketing manager (marketing professional, marketing content provider) may want to implement the following marketing strategy:

show baseball gloves in March and April to customers who have children.

One or more specified marketing strategies can also be associated with a marketing campaign. A marketing campaign is a collection of specified marketing strategies which together are used to achieve a specific overall business objective such as:

clearance sale: to move high-inventory merchandise to make room for new models.

Typically, a marketing manager controls how a specific marketing campaign or strategy should be implemented to influence the buying patterns of consumers viewing the web page 20. The marketing manager is generally not concerned with how the marketing content is laid out on a web page, but is more concerned with what marketing content should be presented. Advantageously, in accordance with the present invention, the marketing manager needs only to know which MPEs 60 are available for use on a web page 20, so that the selection system 100 can be designed to select and provide appropriate data items for different types of MPEs 60. Therefore, once the web page designer and marketing manager have agreed to what MPEs 60 may be used in the web page 20 and what types of data items will be stored in those MPEs 60, the design of the web page 20 and the design of means for selecting data items may occur concurrently and/or independently.

The means for selecting data items from a source of data items in accordance with a specified marketing strategy can be implemented in a selection system 100 in a number of ways. For example, referring to FIG. 1, a rules processing engine 130 can be used. The rules processing engine 130 selects specific items that are to be recommended to potential consumers viewing the web page 20 based on “business rules” that specify a marketing strategy.

A business rule is typically a logic statement of the form:

if (condition) then <action>.

Business rules can be used to specify marketing strategies. For example:

if (this customer belongs to the “young, high-earner” customer profile and has a 20-inch TV in his shopping cart)

then (select a TV with at least a 27-inch screen to be displayed to the consumer).

Application tools 135 may be used by a marketing manager to construct the business rules to be processed by the rules processing engine 130. For example, the application tools 135 can allow marketing managers to express, as business rules, a variety of marketing strategies such as:

(i) Recommend golfing equipment to any retired, male customer who is currently browsing in the “sports” section of the catalog

(ii) Show a “20% off” ad to any customer who has spent at least $1,000 in the past month

(iii) Recommend any item from any electronics category with a price of at least $1,000 to young, high-earners

(iv) Recommend a 27-inch screen TV to any young, high-earner who has a 20-inch TV in his shopping cart.

The application tools 135 also allow marketing managers to define “customer profiles”, which are rules that place customers into groups or segments for use in the interpretation of business rules. Some examples of groups or segments that could be defined may include.

Retired, male customers:

any customer whose gender is “male” and whose occupation is “retired”

Active customers:

any customer who last visited the web site in the past week or who has made a purchase within the past 30 days

Young, high-earners:

any customer who is 30 years of age or younger and who has an income greater than $75,000.

Other application tools 135 can also be used to facilitate the selection of marketing content for display on the web page 20.

The rules processing engine 130 has access to one or more information databases 140 which can store data relating to customer information (e.g. personal information, past order information, information relating to previous visits and browsing habits, etc.), merchant information, inventory, pricing schemes, discounts, tax and shipping rules, customer profiles, etc.

The data in the information databases 140 can be used by the rules processing engine 130 to process the business rules and determine which data items are to be retrieved from the retrieval system 110 to be stored in the MPE 60 for subsequent display on the web page 20.

The source of data items may comprise, for example, separate data item databases 150 in the retrieval system 110. When data items are to be retrieved for display on the web page 20, the rules processing engine 130 of the selection system 100 determines what data items are to be retrieved from the data item databases 150 (or other source of data items) by processing the business rules associated with the MPE 60, and passes to the MPE 60 one or more data item identifiers. The data item identifiers are used by the MPE 60 to retrieve the corresponding data items from the data item databases 150 of the retrieval system 110. This may be performed through a data item retrieval interface 160.

The web page 20 can be implemented as a Java™ Server Page (JSP) and the MPE 60 can be implemented as a collection of Java classes. Preferably, Java and JSPs are used in the implementation of the present invention as they are standard, open technologies which generally allow for a greater degree of portability to different computing platforms compared to that afforded by proprietary technologies.

Furthermore, many of the components of the system 10 may be provided in a commercial web site development application, including IBM's WebSphere Commerce Suite (WCS), for example. In this embodiment of the invention, each MPE 60 is an extension of a Data Bean of the WCS. A Data Bean is a Java Bean that has the ability to populate itself with data items which have been selected by a rules processing engine 130 of a selection system 100 and retrieved from a retrieval system 110. This implementation of the MPE 60 also allows a web page designer to use a WYSIWYG web authoring tool (e.g. IBM's Page Designer) to “drop” the MPE 60 onto a Java Server Page (i.e. a web page 20), and to then “connect” Hypertext Markup Language (HTML) formatting elements (i.e. web page elements 85; e.g., the columns of a table) to the values of the specific attributes of the page element items 80, allowing the corresponding data items to be presented on the Java Server Page.

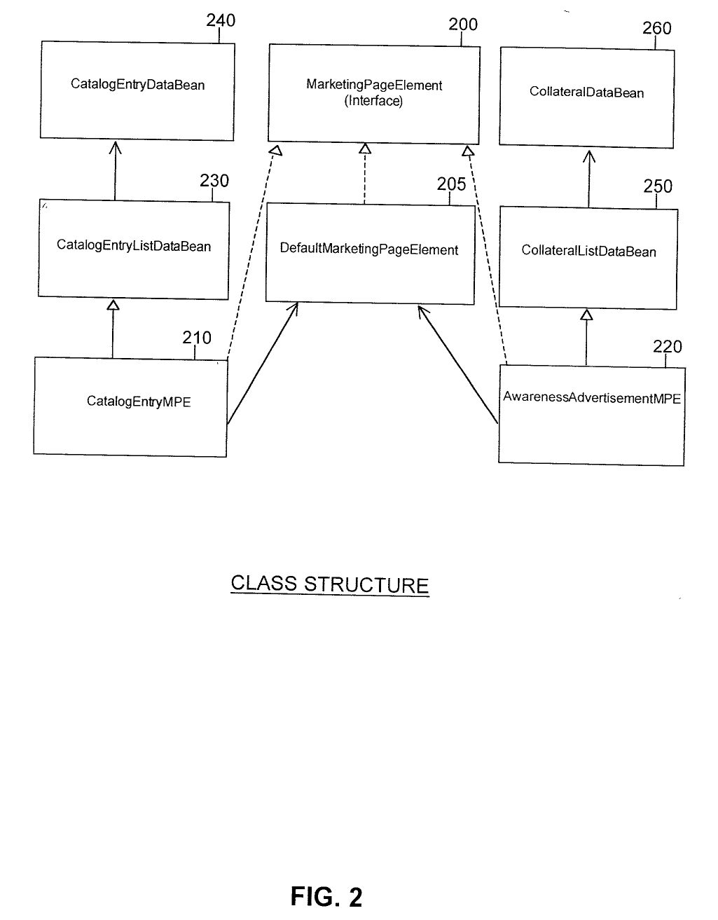

Referring to FIG. 2, a class structure for MPEs 60 is shown. A Marketing Page Element Interface (class) 200 provides an interface used to implement different types of MPEs. The Marketing Page Element Interface 200 can have the following defined general attributes:

Id:

a unique key identifying instances of an MPE

name:

text name

store Id:

identifier of an entity (e.g., a store) to which an instance of a MPE belongs; can be combined with “name” general attribute to create a unique key

executedInitiative Id:

identifier of type of marketing strategy that has been most recently processed

imageURL:

a uniform resource locator (URL) of a graphic which could be displayed along with the marketing content from the current MPE

leadingText:

text which can be displayed along with the marketing content

maximumNumberOfItems:

this general attribute specifies the maximum number of items (i.e., products, coupons, etc.) that can be retrieved (e.g., typically equal to the number of page element items 80)

mediaLink:

a URL to a media element which can be displayed along with the marketing content

typeName:

type of MPE under which the current instance is classified.

General attributes of an MPE 60 are defined for attributes that are common to all MPEs 60. General attributes are not associated with page element items 80, and thus do not relate to specific data items.

A general attribute which specifies an alternate set of items to display when the marketing content server 120 is unavailable, or when the data items to be retrieved from the retrieval system 110 are otherwise not retrievable, may also be defined. This ensures that the web page elements 85 on a web page 20 used to display data items stored in the MPE 60 are not left blank.

Other general attributes may also be defined and used to store information, or to pass data to and from the web page 20, the application modules and elements 70, the selection system 100 and the retrieval system 110. The Marketing Page Element Interface 200 will also define methods that permit these general attributes to be set, and to retrieve the current value of these general attributes. For any particular object which is an instance of a class that implements the Marketing Page Element Interface 200, that object will have the ability to make the values of at least some of these general attributes available for use in the design of a web page 20.

Since the Marketing Page Element Interface 200 is an interface, additional classes are defined to implement specific types of MPEs 60. Preferably, a DefaultMarketingPageElement class 205 which implements the Marketing Page Element Interface 200 is also defined. The DefaultMarketingPageElement class 205 implements some of the behaviour required by the Marketing Page Element Interface 200 which is appropriate for any type of MPE 60. For example, the general attributes id, name, and storeID are common to all types of MPEs 60, and can be implemented in the DefaultMarketingPageElement class 205. It will be appreciated by those skilled in the art that it is desirable to implement behaviour common to all MPEs 60 only once, and this can be achieved using the DefaultMarketingPageElement class 205.

For example, a CatalogEntryMPE class 210 may be defined to implement a specific type of MPE 60. Instances of this class represent MPEs 60 which specifically deliver catalog entries as marketing content. An instance of the CatalogEntryMPE class 210 can contain an instance of the DefaultMarketingPageElement class 205 to which the implementation of some behaviour may be delegated, for example, to provide access to general attributes common to all MPEs 60. The CatalogEntryMPE class 210 defines attributes and behaviour specific to presenting catalog entries on a web page 20.

Similarly, an AwarenessAdvertisementMPE class 220 may be defined to implement a specific type of MPE 60. Instances of this class represent MPEs 60 which specifically deliver marketing collateral items including graphical banner advertisements as marketing content. An instance of the AwarenessAdvertisementMPE class 220 can contain an instance of the DefaultMarketingPageElement class 205 to which some behaviour may be delegated, for example, to provide access to the general attributes common to all MPEs 60. The AwarenessAdvertisementMPE class 220 defines attributes and behaviour specific to presenting marketing collateral items on a web page 20.

A variety of other classes that implement the Marketing Page Element Interface 200 may also be defined, including various forms of price incentives (e.g., coupons, vouchers), bonus items, links to specific web pages elsewhere on the Internet, auctions, or any object for which a WCS Data Bean class (discussed in greater detail below) has already been defined.

Specific types of MPEs 60 may also be defined for use on specific web pages 20 that a viewer might navigate to at a web site. For example, it may be desirable to design a Storefront Marketing Page Element having certain attributes and behaviour specifically applicable for display on the main web page of a web site.

Each type of MPE 60 which is implemented using the Marketing Page Element Interface 200 is also a Data Bean. For example, the CatalogEntryMPE class 210 defines a Catalog Entry MPE, and extends the CatalogEntryListDataBean class 230 which provides a display or presentation mechanism for a list of catalog entries. An instance of the CatalogEntryListDataBean class 230 consists of a collection of objects defined by the CatalogEntryDataBean class 240 which provides a display or presentation mechanism for individual catalog entries (e.g., methods for displaying the value of catalog entry specific attributes on a JSP). In essence, the collection of objects defined by the CatalogEntryDataBean class 240 represents the set of page element items 80 associated with the given instance of the Catalog Entry MPE. The specific attributes defined in the CatalogEntryDataBean class 240 may include:

catalogEntry Id:

a unique identifier which is associated with a data item used to retrieve the data item from the retrieval system 110 for display

description:

a description of the data item.

Since an instance of the CatalogEntryDataBean class 240 is also a Data Bean, an instance of the CatalogEntryMPE class 210 is capable of populating itself with data, as well as causing that data to be displayed on a JSP.

Thus, each Catalog Entry MPE comprises a set of Catalog Entry page element items (the set represents a list of catalog entries), where each Catalog Entry page element item has specific attributes (e.g., catalogEntryId) which can be associated with data items, the data items having been retrieved from the retrieval system 110 and stored in the Catalog Entry MPE.

Similarly, the AwarenessAdvertisementMPE class 220 defines an Awareness Advertisement MPE, which extends the CollateralListDataBean class 250 which provides a display mechanism for a list of marketing collateral items (including banner advertisements). An instance of the CollateralListDataBean class 250 consists of a collection of objects defined by the CollateralDataBean class 260, which provides a display or presentation mechanism for individual marketing collateral items (e.g., methods for displaying the value of collateral item specific attributes on a JSP). In essence, the collection of objects defined by the CollateralDataBean class 260 represents the set of page element items 80 associated with the given instance of the Awareness Advertisement MPE. The specific attributes defined in the CollateralDataBean class 260 may include:

marketing text:

text to appear with the advertisement

location:

identifier of the source of the advertisement

language Id:

the language of the advertisement

URL Link:

a hyperlink associated with the advertisement.

Since an instance of the CollateralDataBean class 260 is also a Data Bean, an instance of the AwarenessAdvertisementMPE class 220 is capable of populating itself with data, as well as causing that data to be displayed on a JSP.

Thus, each Awareness Advertisement MPE comprises a set of Awareness Advertisement page element items (the set represents a list of marketing collateral items), where each Awareness Advertisement page element item has specific attributes (e.g., marketing Text) which can be associated with data items, the data items having been retrieved from the retrieval system 110 and stored in the Awareness Advertisement MPE.

Other types of MPEs 60 can be defined in a similar fashion, and the specific attributes of the various associated Data Bean classes will vary depending on the type of MPE 60 being defined.

Each MPE 60 can be uniquely identified within a web page 20 so that both web page designers and marketing managers can work independently with the MPEs 60 and identify them.

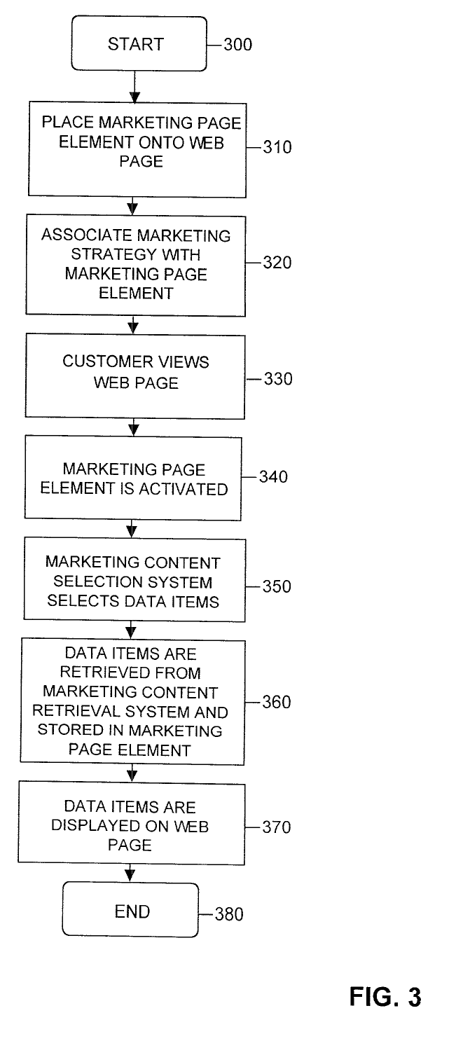

Referring to FIG. 3, a method of presenting marketing content on a web page 20 is shown as a series of steps commencing at step 300.

At step 310, a web page designer places an MPE 60 onto a web page 20 using web authoring tools such as IBM's Page Designer, or other web authoring tools as are known. The web page designer arranges web page elements 85 in a desired manner, each web page element 85 capable of displaying or presenting a data item by retrieving the value of the corresponding specific attribute of a page element item 80.

At step 320, a marketing manager specifies a marketing strategy and associates the marketing strategy with the MPE 60 placed on the web page 20 at step 310. Application tools 135 designed for these purposes may be used by the marketing manager. The marketing manager ensures that components of the selection system 100 (e.g., the rules processing engine 130) are adapted to select data items in accordance with the marketing strategy.

At step 330, a viewer (consumer) navigates to the web page 20 on which the MPE 60 was placed at step 310.

At step 340, the MPE 60 is activated by an application module 70 connected to the web page 20.

At step 350, the selection system 100 is queried for data item identifiers, specifying the MPE 60 as input. Information pertaining to the viewer may be passed in this way to the selection system 100 (and stored therein) to allow for the selection of marketing content personalized to the viewer. Data item identifiers are passed back to and stored in the MPE 60. The number of data item identifiers provided by the selection system 100 may be restricted to a maximum number as defined by the relevant general attributes of the MPE 60. This allows for greater operational efficiency since items exceeding the maximum limit that should not be displayed will not be retrieved.

At step 360, the MPE 60 populates itself with data items retrieved from the retrieval system 110, as identified by the data item identifiers received from the selection system 100 at step 350. The data items are associated with page element items 80 of the MPE 60.

At step 370, the web page 20 displays or presents to the viewer the data items as specified for each web page element 85 in the code of the web page 20, in an attempt to induce the consumer to make purchases in accordance with the specified marketing strategy.

Step 380 marks the end of the method of presenting marketing content on a web page.

Steps 310 and 320 may occur concurrently, since the design of the web page and the design of the means for selecting data items can be performed independently once the page element items 80 that will be associated with a specific type of MPE 60 to be placed on the web page are known.

The present invention allows for separation of the concerns of the web site designer from the concerns of the marketing professional; the former being interested in the web page layout and the latter being interested in delivering marketing content to potential consumers. In particular, in accordance with the present invention, the web page designer can make changes to the layout of the web page 20 without requiring that changes be made to the selection system 100. Conversely, changes in the implementation of marketing strategies within the selection system 100 can be performed without requiring that changes be made to the layout of the web page 20. Still further, in some cases, the data items themselves stored in the data item databases 150 of the retrieval system 110 can be modified without requiring changes to the design of the web page 20 or to the design of the selection system 100, and vice-versa.

In the preferred embodiment of the invention, data items retrieved from the data item databases 150 typically comprise text or images. “Presentation” of these data items can be achieved by displaying them on the web page 20. However, other data items may be presented on a web page 20, and the presentation of these other data items need not necessarily require the “display” of those items, per se. Such other data items may include hyperlinks to other documents over the Internet, audio files, video files, movies, animations, documents, or any objects capable of accepting input or presenting output.

In variant embodiments of the invention, a web page 20 may contain more than one MPE 60, and each MPE 60 may be connected to a different selection system 100 and/or retrieval system 110.

In variant embodiments of the invention, the selection system 100 may comprise a component other than a rules processing engine 130. For example, a set of database tables where data items can be selected by looking in a given cell of a table constructed in accordance with a marketing strategy may be used. Alternatively, the selection system 100 may comprise a collaborative filtering engine which observes shoppers and dynamically recommends and selects items based on the observed patterns of behaviour. Optionally, the selection of data items by a collaborative filtering engine may be performed in accordance with a marketing strategy (e.g. recommending items based on what is in the consumer's shopping cart at a particular point in time). Alternatively, any selection program, system or engine (or combination of these) which is able to select items in accordance with a marketing strategy can be used as a selection component in the selection system 100.

In variant embodiments of the invention, one or more components of the system 10 may be adapted to allow sets of data items retrieved from the retrieval system 110 to be ranked in a specified manner, and/or to display sets of data items on the web page 20 to a viewer in a specified order.

In variant embodiments of the invention, the source of data items is not limited to data item databases 150, but may also include data streams, storage devices or memory devices.

In variant embodiments of the invention, the web page 20 and MPEs 60 may not be Java-based, but instead, either or both components of the system 10 may be implemented using different programming languages and technologies, as are known.

With respect to the elements of the system 10 for presenting marketing content on a web page 20 described in this specification, it will be apparent to those skilled in the art that the execution of various tasks need not be performed by the particular component specified in the description of the preferred embodiment of the invention. It will also be apparent to those skilled in the art that components of the system 10 need not reside on the specific server as described in the specification, and need not be implemented in the specific manner as described in the specification. For example, the components of the system 10 may physically reside on a single server, or may be distributed across several servers. Data stored in databases (e.g. 140, 150) may be stored in a single database, or distributed across several databases or other storage means. The components of each of the selection system 100 and the retrieval system 110 may be physically located on different servers, and where communication between them and other components of the system 10 can be maintained by any data communication means as is known, including a network connection, a TCP/IP connection, wireless communication means, or other known connection means. Further, a MPE 60 may be connected, directly or indirectly, to multiple selection systems and/or multiple retrieval systems, any or all of which may be used in the selection and retrieval of data items for display on a web page 20.

As will be apparent to those skilled in the art, other variations, modifications and adaptations of the systems and methods described herein are possible without departing from the present invention, the scope of which is defined in the claims.

The embodiments of the invention in which an exclusive property or privilege is claimed are defined as follows:

1. A system for presenting marketing content on a web page, the system comprising:
(a) a marketing page element, said marketing page element providing storage for data items;
(b) a web page connected to said marketing page element for presenting said data items; and
(c) a marketing content selection system connected to said marketing page element, wherein said marketing content selection system is adapted to select said data items to be stored in said marketing page element.

2. The system for presenting marketing content on a web page as claimed in claim 1, wherein said marketing page element comprises a plurality of marketing page element items, and wherein at least one data item stored in said marketing page element is connected to one of said plurality of marketing page element items.

3. The system for presenting marketing content on a web page as claimed in claim 2, wherein said web page comprises a plurality of web page elements, wherein each of said web page elements is connected to a marketing page element item of said plurality of marketing page element items, and wherein each of said web page elements is used to present a data item connected to said marketing page element item.

4. The system for presenting marketing content on a web page as claimed in claim 1, wherein said marketing content selection system is adapted to determine data items for storage in said marketing page element in accordance with a marketing strategy.

5. The system for presenting marketing content on a web page as claimed in claim 4, wherein the marketing content selection system determines data items to be stored in said marketing page element based on information available to said marketing content selection system pertaining to the person viewing the web page.

6. The system for presenting marketing content on a web page as claimed in claim 1 further comprising a marketing content retrieval system connected to said marketing page element, said marketing content retrieval system adapted to provide said data items to said marketing page element for storage in said marketing page element.

7. The system for presenting marketing content on a web page as claimed in claim 6, wherein the marketing content retrieval system comprises a first source of data items, wherein data items are retrieved from said first source of data items for subsequent storage in said marketing page element, said first source of data items comprising at least one of the following: a database, a data stream, a storage device, a memory device.

8. The system for presenting marketing content on a web page as claimed in claim 7, wherein each data item in said first source of data items comprises one of the following: text, an image, an audio file, a video file, a movie, a document, a hyperlink, an animation, an object capable of accepting input, an object capable of presenting output.

9. The system for presenting marketing content on a web page as claimed in claim 8, wherein the marketing content retrieval system is further adapted to provide at least one data item to said marketing page element from a pre-determined second source of data items in the event that at least one data item to be stored in said marketing page element as determined by the marketing content selection system cannot be retrieved from the first source of data items.

10. The system for presenting marketing content on a web page as claimed in claim 1, wherein the marketing page element is a Data Bean, and wherein said web page is a Java Server Page.

11. The system for presenting marketing content on a web page as claimed in claim 1, wherein the marketing content selection system comprises at least one of the following components: a rules processing engine, a table, a collaborative filtering engine, a selection program.

12. The system for presenting marketing content on a web page as claimed in claim 3 further comprising at least one of the following:
(i) a first set of tools for making modifications to the manner in which the marketing content selection system determines the data items to be stored in said marketing page element, wherein the modifications can be effected without changing either the layout of said web page elements on said web page or said data items;
(ii) a second set of tools for making modifications to said data items, wherein the modifications can be effected without changing either the layout of said web page elements on said web page or the manner in which the marketing content selection system determines the data items to be stored in said marketing page element; and
(iii) a third set of tools for making modifications to the layout of said web page elements on said web page, wherein the modifications can be effected without changing either said data items or the manner in which the marketing content selection system determines the data items to be stored in said marketing page element.

13. A method of presenting marketing content on a web page using a marketing page element, the method comprising the steps of:
(a) selecting a plurality of data items using a marketing content selection system;
(b) storing said data items in said marketing page element; and
(c) presenting said data items on said web page.

14. The method as claimed in claim 13, wherein said marketing page element comprises a plurality of marketing page element items, and wherein at least one data item stored in said marketing page element is connected to one of said plurality of marketing page element items.

15. The method as claimed in claim 14, wherein said web page comprises a plurality of web page elements, wherein each of said web page elements is connected to a marketing page element item of said plurality of marketing page element items, and wherein each of said web page elements is used to present a data item connected to said marketing page element item.

16. The method as claimed in claim 13, wherein the selecting of data items in step (a) is performed in accordance with a marketing strategy.

17. The method as claimed in claim 16, wherein the selecting of data items in step (a) is based on information pertaining to the person viewing the web page.

18. The method as claimed in claim 13 further comprising between steps (a) and (c), the step of retrieving data items selected in step (a) from a marketing content retrieval system, said marketing content retrieval system adapted to provide data items to said marketing page element.

19. The method as claimed in claim 18, wherein said marketing content retrieval system comprises a first source of data items, wherein data items are retrieved from said first source of data items for subsequent storage in said marketing page element, said first source of data items comprising at least one of the following: a database, a data stream, a storage device, a memory device.

20. The method as claimed in claim 19, wherein each data item in said first source of data items comprises one of the following: text, an image, an audio file, a video file, a movie, a document, a hyperlink, an animation, an object capable of accepting input, an object capable of presenting output.

21. The method as claimed in claim 20, wherein the method also comprises the step of retrieving at least one data item from a second source of data items when at least one of said plurality of selected data items cannot be retrieved from said first source of data items.

22. The method as claimed in claim 13, wherein said marketing page element is a Data Bean, and wherein said web page is a Java Server Page.

23. The method as claimed in claim 13, wherein the selecting of data items in step (a) is performed by at least one of the following components: a rules processing engine, a table, a collaborative filtering engine, a selection program.

24. The method as claimed in claim 15 wherein the method further comprises at least one of the following steps:
(i) making modifications to the manner in which the selecting of data items in step (a) is made, wherein the modifications can be effected without changing either the layout of the web page elements on the web page or said data items;
(ii) making modifications to said data items, wherein the modifications can be effected without changing either the layout of the web page elements on the web page or the manner in which the selecting of data items in step (a) is made; and
(iii) making modifications to the layout of the web page elements on the web page, wherein the modifications can be effected without changing either said data items or the manner in which the selecting of data items in step (a) is made.

25. A computer-readable medium having stored thereon computer-executable instructions for presenting marketing content on a web page using a marketing page element by performing the steps comprising:
(a) selecting a plurality of data items using a marketing content selection system;
(b) storing said data items in said marketing page element; and
(c) presenting said data items on said web page.

26. The computer-readable medium as claimed in claim 25, wherein said marketing page element comprises a plurality of marketing page element items, and wherein at least one data item stored in said marketing page element is connected to one of said plurality of marketing page element items.

27. The computer-readable medium as claimed in claim 26, wherein said web page comprises a plurality of web page elements, wherein each of said web page elements is connected to a marketing page element item of said plurality of marketing page element items, and wherein each of said web page elements is used to present a data item connected to said marketing page element item.

28. The computer-readable medium as claimed in claim 25, wherein the selecting of data items in step (a) is performed in accordance with a marketing strategy.

29. The computer-readable medium as claimed in claim 28, wherein the selecting of data items in step (a) is based on information pertaining to the person viewing the web page.

30. The computer-readable medium as claimed in claim 25 further comprising between steps (a) and (c), the step of retrieving data items selected in step (a) from a marketing content retrieval system, said marketing content retrieval system adapted to provide data items to said marketing page element.

31. The computer-readable medium as claimed in claim 30, wherein said marketing content retrieval system comprises a first source of data items, wherein data items are retrieved from said first source of data items for subsequent storage in said marketing page element, said first source of data items comprising at least one of the following: a database, a data stream, a storage device, a memory device.

32. The computer-readable medium as claimed in claim 31, wherein each data item in said first source of data items comprises one of the following: text, an image, an audio file, a video file, a movie, a document, a hyperlink, an animation, an object capable of accepting input, an object capable of presenting output.

33. The computer-readable medium as claimed in claim 32, wherein the step of retrieving at least one data item from a second source of data items when at least one of said plurality of selected data items cannot be retrieved from said first source of data items is also performed.

34. The computer-readable medium as claimed in claim 25, wherein said marketing page element is a Data Bean, and wherein said web page is a Java Server Page.

35. The computer-readable medium as claimed in claim 25, wherein the selecting of data items in step (a) is performed by at least one of the following components: a rules processing engine, a table, a collaborative filtering engine, a selection program.

36. The computer-readable medium as claimed in claim 27 wherein at least one of the following steps is also performed:
(i) making modifications to the manner in which the selecting of data items in step (a) is made, wherein the modifications can be effected without changing either the layout of the web page elements on the web page or said data items;
(ii) making modifications to said data items, wherein the modifications can be effected without changing either the layout of the web page elements on the web page or the manner in which the selecting of data items in step (a) is made; and
(iii) making modifications to the layout of the web page elements on the web page, wherein the modifications can be effected without changing either said data items or the manner in which the selecting of data items in step (a) is made.

37. A computer program comprising computer program code means adapted to perform all the steps of claim 13 when said program is run on a computer.

38. A computer program as claimed in claim 37 embodied on a computer readable medium.

39. A software product for presenting marketing content on a web page, said software product comprising:
(a) a marketing page element, said marketing page element providing storage for data items, said marketing page element connected to a web page adapted to present said data items; and
(b) a marketing content selection system connected to said marketing page element, wherein said marketing content selection system is adapted to select said data items to be stored in said marketing page element.

40. The software product as claimed in claim 39, wherein said marketing page element comprises a plurality of marketing page element items, and wherein at least one data item stored in said marketing page element is connected to one of said plurality of marketing page element items.

41. The software product as claimed in claim 40, wherein said web page comprises a plurality of web page elements, wherein each of said web page elements is connected to a marketing page element item of said plurality of marketing page element items, and wherein each of said web page elements is used to present a data item connected to said marketing page element item.

42. The software product as claimed in claim 39, wherein said marketing content selection system is adapted to determine data items for storage in said marketing page element in accordance with a marketing strategy.

43. The software product as claimed in claim 42, wherein the marketing content selection system determines data items to be stored in said marketing page element based on information available to said marketing content selection system pertaining to the person viewing the web page.

44. The software product as claimed in claim 39 further comprising a marketing content retrieval system connected to said marketing page element, said marketing content retrieval system adapted to provide said data items to said marketing page element for storage in said marketing page element.

45. The software product as claimed in claim 44, wherein the marketing content retrieval system comprises a first source of data items, wherein data items are retrieved from said first source of data items for subsequent storage in said marketing page element, said first source of data items comprising at least one of the following: a database, a data stream, a storage device, a memory device.

46. The software product as claimed in claim 45, wherein each data item in said first source of data items comprises one of the following: text, an image, an audio file, a video file, a movie, a document, a hyperlink, an animation, an object capable of accepting input, an object capable of presenting output.

47. The software product as claimed in claim 46, wherein the marketing content retrieval system is further adapted to provide at least one data item to said marketing page element from a pre-determined second source of data items in the event that at least one data item to be stored in said marketing page element as determined by the marketing content selection system cannot be retrieved from the first source of data items.

48. The software product as claimed in claim 39, wherein the marketing page element is a Data Bean, and wherein said web page is a Java Server Page.

49. The software product as claimed in claim 39, wherein the marketing content selection system comprises at least one of the following components: a rules processing engine, a table, a collaborative filtering engine, a selection program.

50. The software product as claimed in claim 41 further comprising at least one of the following:
(i) a first set of tools for making modifications to the manner in which the marketing content selection system determines the data items to be stored in said marketing page element, wherein the modifications can be effected without changing either the layout of said web page elements on said web page or said data items;
(ii) a second set of tools for making modifications to said data items, wherein the modifications can be effected without changing either the layout of said web page elements on said web page or the manner in which the marketing content selection system determines the data items to be stored in said marketing page element; and
(iii) a third set of tools for making modifications to the layout of said web page elements on said web page, wherein the modifications can be effected without changing either said data items or the manner in which the marketing content selection system determines the data items to be stored in said marketing page element.

51. A computer program product comprising:
a computer-readable signal-bearing medium;
means in said medium for accomplishing the method of any of claims 13 to 24.

52. The product of claim 51 wherein said medium is a recordable data storage medium.

53. The product of claim 51 wherein said medium is a modulated carrier signal.

54. The product of claim 53 wherein said signal is a transmission over a network.

55. The product of claim 54 wherein said network is the Internet.
